(19) United States
(12) Patent Application Publication
(10) Pub. No.: US 2025/0244532 A1
(43) Pub. Date: Jul. 31, 2025

(54) OPTICAL MODULE FOR TESTING LINE CARD

(71) Applicant: Cisco Technology, Inc., San Jose, CA (US)

(72) Inventor: Marco MAZZINI, Seville (ES)

(21) Appl. No.: 18/424,496

(22) Filed: Jan. 26, 2024

(51) Int. Cl. G02B 6/26; G02B 6/38

(52) U.S. Cl. CPC G02B 6/266; G02B 6/3825

(57) ABSTRACT

An optical module includes an optical connector port, a plurality of variable optical attenuators, a first polarization controller, and an output port. The optical connector port connects to an optical port on a line card and receives a plurality of input optical signals from the line card when the optical connector port is connected to the optical port on the line card. The plurality of variable optical attenuators produce a plurality of attenuated optical signals based on the plurality of input optical signals. The first polarization controller produces a plurality of output optical signals based on the plurality of attenuated optical signals. The output port outputs the plurality of output optical signals.

### TECHNICAL FIELD

Embodiments presented in this disclosure generally relate to optical modules. More specifically, embodiments disclosed herein relate to optical modules for testing optical line cards.

### BACKGROUND

Optical line cards may be arranged in racks or chasses (e.g., in datacenters). Test equipment may be expensive and may not always be accessible to customers or service engineers. If equipment is included in or on the racks that host optical line cards to be tested, then the equipment increases the space and real estate requirements for the optical systems. As a result, fewer optical line cards may be installed in the racks or chasses.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example optical system.

FIGS. 2A and 2B illustrate an example optical module in the system of FIG. 1.

FIG. 3 illustrates an example optical module in the system of FIG. 1.

FIG. 4 illustrates an example optical module in the system of FIG. 1.

FIG. 5 illustrates an example optical module in the system of FIG. 1.

FIG. 6 illustrates an example optical module in the system of FIG. 1.

FIG. 7 illustrates an example optical system.

FIG. 8 is a flowchart of an example method performed by the system of FIG. 1 or FIG. 7.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes an optical module for testing line cards. According to an embodiment, an optical module includes an optical connector port, a plurality of variable optical attenuators, a first polarization controller, and an output port. The optical connector port connects to an optical port on a line card and receives a plurality of input optical signals from the line card when the optical connector port is connected to the optical port on the line card. The plurality of variable optical attenuators produce a plurality of attenuated optical signals based on the plurality of input optical signals. The first polarization controller produces a plurality of output optical signals based on the plurality of attenuated optical signals. The output port outputs the plurality of output optical signals.

According to another embodiment, a method includes connecting, by an optical connector port, an optical module to an optical port on a line card and receiving, at the optical module and through the optical connector port, a plurality of input optical signals from the line card when the optical connector port is connected to the optical port on the line card. The method also includes producing, by a plurality of variable optical attenuators of the optical module, a plurality of attenuated optical signals based on the plurality of input optical signals, producing, by a first polarization controller of the optical module, a plurality of output optical signals based on the plurality of attenuated optical signals, and outputting, by an output port of the optical module, the plurality of output optical signals.

According to another embodiment, an optical module includes an optical connector port, a wavelength division multiplexing filter, a plurality of variable optical attenuators, a multiplexer, and a first polarization controller. The optical connector port connects to an optical port on a line card and receives a plurality of input optical signals from the line card when the optical connector port is connected to the optical port on the line card. The wavelength division multiplexing filter passes a plurality of wavelengths of the plurality of input optical signals. The plurality of variable optical attenuators produces a plurality of attenuated optical signals based on the passed plurality of wavelengths of the plurality of input optical signals. The multiplexer produces an intermediate optical signal based on the plurality of attenuated optical signals. The first polarization controller produces a plurality of output optical signals based on the intermediate optical signal.

### EXAMPLE EMBODIMENTS

The present disclosure describes an optical module that connects to an optical line card to condition and direct optical signals in and from the optical line card to testing equipment. The optical module includes variable optical attenuators that attenuate the optical signals and one or more polarization controllers that adjust the polarization of the optical signals. The optical module may output the conditioned optical signals to test equipment to test the optical line card, or directly back to the optical line card. In this manner, the optical line card does not need to include test equipment, which reduces the space and real estate requirements for the optical line card.

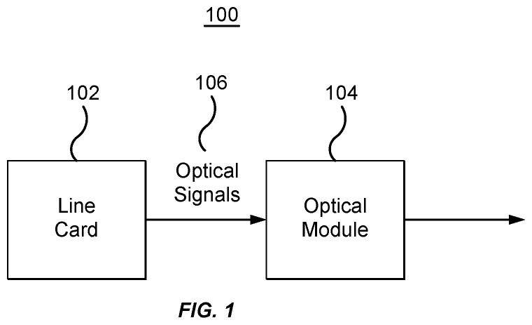

FIG. 1 illustrates an example optical system 100. As seen in FIG. 1, the system 100 includes a line card 102 and an optical module 104. Generally, the optical module 104 conditions or handles optical signals 106 from the line card 102. The optical module 104 may then pass the conditioned optical signals to one or more testing units to test the line card 102. In this manner, testing equipment does not need to be included with the line card 102, which reduces the area or space requirements of the line card 102 in certain embodiments.

The line card 102 is an optical line card that transmits, receives, or handles optical signals. The line card 102 may be installed in a rack or chassis. The line card 102 transmits or receives optical signals for any optical application. The line card 102 may need to be tested to ensure that the line card 102 is operating correctly. In existing optical systems, testing equipment is included with the line card, so that the line card may be tested. The testing equipment, however, increases the size and area requirements of the line card. In the example of FIG. 1, some of the testing equipment may be excluded from the line card 102. As a result, the line card 102 occupies less space than existing line cards.

The optical module 104 plugs into or otherwise connects to the line card 102. For example, the optical module 104 may include an optical connector port that connects to the line card 102. After the optical module 104 is connected to the line card 102, the line card 102 may transmit optical signals 106 to the optical module 104 through the connection. The optical module 104 conditions or handles the optical signals 106. The optical module 104 then directs the conditioned optical signals to test equipment that analyzes the conditioned optical signals to determine whether the line card 102 is operating correctly. In this manner, the optical module 104 allows the testing equipment to be separated from the line card 102. As a result, the line card 102 occupies less space than existing line cards in certain embodiments.

The optical module 104 includes optical components that condition the optical signals 106. For example, the optical module 104 may include one or more variable optical attenuators that attenuate the optical signals 106 from the line card 102. The optical module 104 may also include one or more polarization controllers that modify the polarization of the attenuated optical signals. The optical module 104 may include additional optical components, such as filters before the variable optical attenuators and multiplexers between the variable optical attenuators and the polarization controllers. The optical module 104 outputs the conditioned optical signals to testing equipment that analyze the conditioned optical signals to test the line card 102.

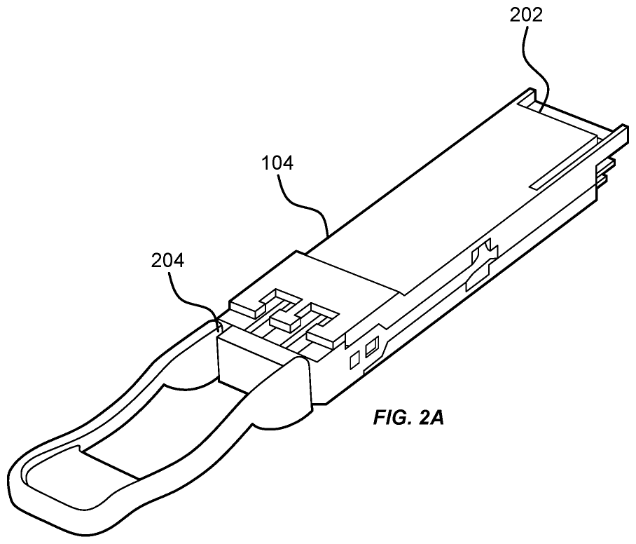

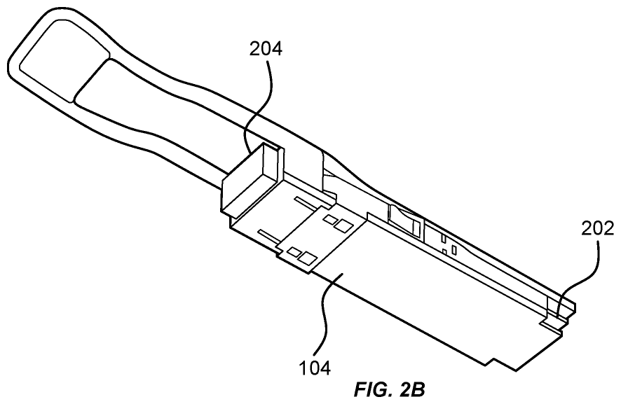

FIGS. 2A and 2B illustrate an example optical module 104 in the system 100 of FIG. 1. As seen in FIG. 2A, the optical module 104 includes an electrical connector 202 and an input/output optical connector port 204 (which may also be referred to as the optical port 204 or the port 204). The electrical connector 202 and the input/output optical connector port 204 are positioned at opposite ends of the optical module 104. The electrical connector 202 may be inserted or plugged into the line card 102 such that the optical module is turned ON and prepared to receive a signal from the line card. The optical connector port 204 may be optically coupled or connected to the line card 102 (e.g., using an optical fiber or connector). The line card 102 transmits optical signals 106 into the optical module 104 through the input/output connector port 204 (e.g., through the input side of the connector port 204). The optical module 104 conditions or handles the optical signals 106. The optical module 104 then outputs the conditioned optical signals through the input/output connector port 204 (e.g., through the output side of port 204) to testing equipment, or back to line card optical input.

FIG. 2B shows an underside of the optical module 104. As seen in FIG. 2B, the connector 202 and the optical connector port 204 are positioned at opposite ends of the optical module 104. The connector 202 may be inserted or plugged into the line card 102. The optical port 204 may be optically coupled to the line card 102 to receive the optical signals 106 from the line card 102. The optical module 104 outputs conditioned optical signals through the optical port 204.

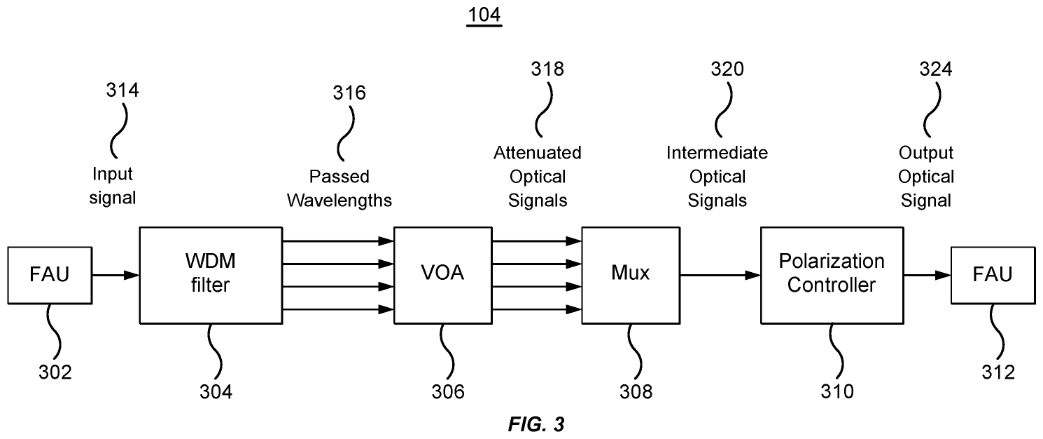

FIG. 3 illustrates an example optical module 104 in the system 100 of FIG. 1. In the example of FIG. 3, the optical module 104 may condition a signal coming from a two kilometer reach transceiver module, which may also be referred to as FR4. The optical module 104 also supports at least four optical channels. As seen in FIG. 3, the optical module 104 includes a fiber array unit 302, a wavelength division multiplexing filter 304, one or more variable optical attenuators 306, one or more multiplexers 308, one or more polarization controllers 310, and a fiber array unit 312.

The fiber array unit 302 includes multiple optical fibers that direct an optical signal from the line card 102 to the filter 304. The fiber array unit 302 may connect to or be part of the optical port 204. For example, optically coupling the port 204 to the line card 102 may allow the fiber array unit 302 to receive one or more optical signals from the line card 102. The fiber array unit 302 directs the optical signals as an input signal 314 to the filter 304.

The wavelength division multiplexing filter 304 may be a course wavelength division multiplexing filter. The filter 304 receives the input signal 314 from the fiber array unit 302. The filter 304 then separates and passes particular wavelengths of the input signal 314 to the variable optical attenuators 306. The filter 304 may filter out the other wavelengths from the input signal 314. As a result, the filter 304 directs passed wavelengths 316 of the input signal 314 to the variable optical attenuators 306 as separate optical signals.

The variable optical attenuators 306 attenuate the passed wavelengths 316 from the filter 304 to produce attenuated optical signals 318. By attenuating the passed wavelengths 316, the variable optical attenuators 306 reduce or trim the power levels in the passed wavelengths 316. The amount of reduction may be adjusted for each of the variable optical attenuators 306. For example, the reduction in power may be manually adjusted or adjusted by an electrical signal applied to the variable optical attenuators 306. The variable optical attenuators 306 direct the attenuated optical signals 318 to the multiplexer 308.

The multiplexer 308 may be an optical multiplexer that combines the attenuated optical signals 318 into fewer optical fibers. In the example of FIG. 3, the multiplexer 308 may combine the attenuated optical signals 318 into an intermediate optical signal 320 on a single optical fiber. The multiplexer 308 then directs the intermediate optical signal 320 to the polarization controller 310.

The polarization controller 310 adjusts the polarization of the intermediate optical signal 320 to produce an output optical signal 324. The polarization controller 310 directs the output optical signal 324 to the fiber array unit 312. The fiber array unit 312 includes one or more optical fibers that carry the output optical signal 324 out of the optical module 104. The fiber array unit 312 may be included in the port 204. In some embodiments, the fiber array unit 312 directs the output optical signal 324 to test equipment that analyzes the output optical signal 324 to test whether the line card 102 is operating correctly.

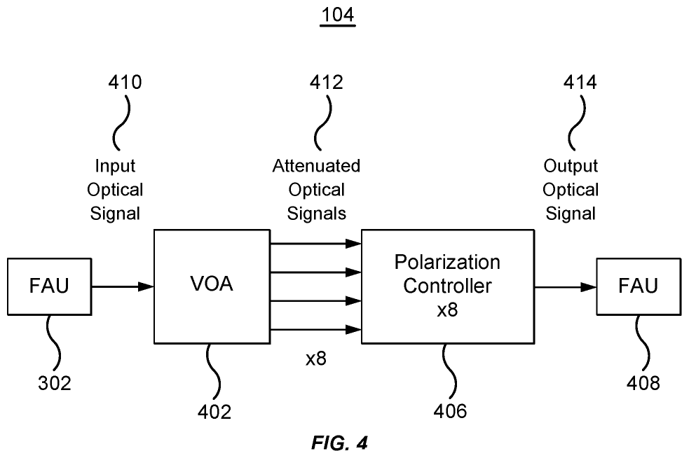

FIG. 4 illustrates an example optical module 104 in the system 100 of FIG. 1. In the example of FIG. 4, the optical module 104 may condition a signal coming from a 500 meter reach transceiver module, which may also be referred to as DR4. The optical module 104 may include four or more optical channels. As seen in FIG. 4, the optical module 104 includes the fiber array unit 302, one or more variable optical attenuators 402, one or more polarization controllers 406, and a fiber array unit 408.

The fiber array unit 302 may include one or more optical fibers that receive one or more optical signals from the line card 102. The fiber array unit 302 may connect or be included in the port 204. The fiber array unit 302 may receive the optical signals from the line card 102 when the port 204 is optically coupled to the line card 102. The fiber array unit 302 directs the optical signals as an input optical signal 410 to the variable optical attenuators 402.

The variable optical attenuators 402 reduce the signal power in the input optical signal 410. The amount of reduction may be controlled or adjusted. For example, the amount of reduction may be manually adjusted or may be adjusted by an electrical signal into the variable optical attenuators 402. The variable optical attenuators 402 produce attenuated optical signals 412 and direct the attenuated optical signals 412 to the polarization controllers 406.

The polarization controllers 406 receive the attenuated optical signals 412 from the variable optical attenuators 402. The polarization controllers 406 adjust the polarization of the attenuated optical signals 412 to produce the output optical signal 414. The polarization controllers 406 direct the output optical signal 414 to the fiber array unit 408.

The fiber array unit 408 may include one or more optical fibers that direct the output optical signal 414 out of the optical module 104. The fiber array unit 408 may be connected to or included in the port 204. The fiber array unit 408 directs the output optical signal 414 to test equipment that analyzes the output optical signal 414 to test whether the line card 102 is operating correctly.

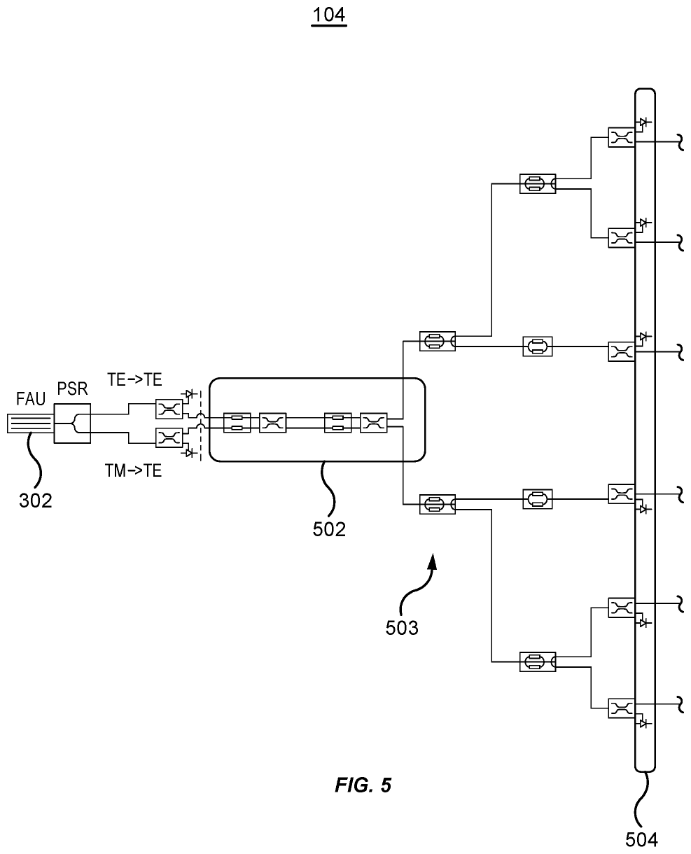

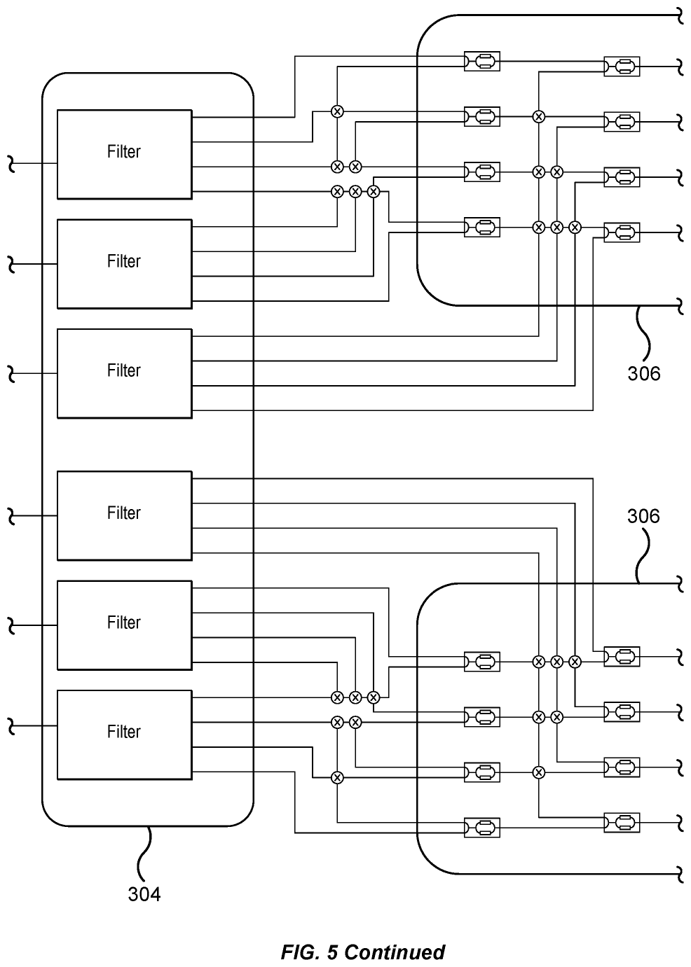

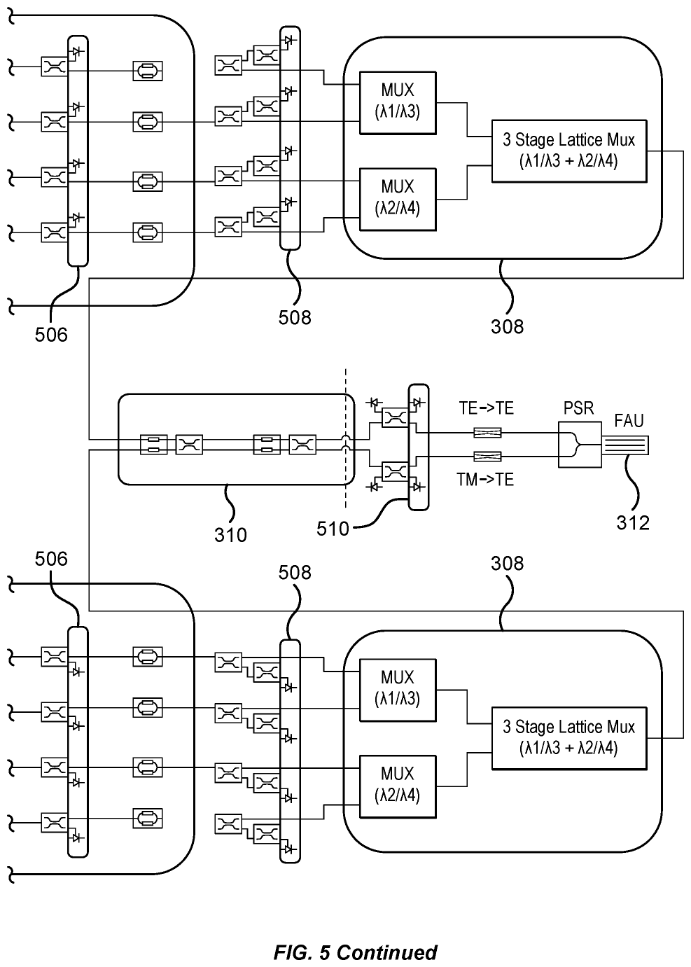

FIG. 5 illustrates an example optical module 104 in the system 100 of FIG. 1. Generally, FIG. 5 is a more detailed schematic diagram of the optical module 104 of FIG. 3. As seen in FIG. 5, the optical module 104 includes the fiber array unit 302 that receives the optical signals from the line card 102. The fiber array unit 302 directs the optical signals to polarization controllers 502. A polarization splitter rotator may split the optical signals into transverse electric and transverse magnetic components and rotate the transverse magnetic component into a transverse electric component. The transverse electric components may then be directed to the polarization controllers 502.

The polarization controllers 502 adjust the polarization of the transverse electric components. The polarization controllers 502 then direct the adjusted transverse electric components to a switch network 503 that directs these components to the filter 304. As seen in FIG. 5, the switch network 503 may include photodiodes 504 that tap into the signals entering the filter 304. The photodiodes 504 produce electrical signals based on the optical signals entering the filter 304. These electrical signals may be analyzed to monitor the optical signals entering the filter 304.

The filter 304 passes certain wavelengths of the optical signals to the variable optical attenuators 306. The filter 304 may be formed using multiple filters. The variable optical attenuators 306 attenuate the signal power in the passed wavelengths from the filter 304. In some embodiments, the variable optical attenuators 306 include photodiodes 506 that tap the optical signals in the variable optical attenuators 306. The photodiodes 506 produce electrical signals based on the optical signals in the variable optical attenuators 306. These electrical signals may be analyzed to monitor the optical signals in the variable optical attenuators 306. The variable optical attenuators 306 direct the attenuated optical signals to the multiplexers 308.

The multiplexers 308 combine the attenuated optical signals onto a single optical fiber. The multiplexers 308 then direct the combined optical signals to the polarization controllers 310. The multiplexers 308 may include multiple multiplexers that combine different attenuated optical signals. In certain embodiments, the optical module 104 includes photodiodes 508 that tap into the optical signals entering the multiplexers 308. The photodiodes 508 produce electrical signals based on the optical signals entering the multiplexers 308. These electrical signals may be analyzed to monitor the optical signals entering the multiplexers 308.

The polarization controllers 310 adjust the polarizations of the combined optical signals from the multiplexers 308. The polarization controllers 310 output the adjusted signals to the fiber array unit 312. The polarization splitter rotator may rotate and combine the optical signals from the polarization controllers 310 and direct the combined optical signal to the fiber array unit 312. In some embodiments, the optical module 104 includes photodiodes 510 that tap the optical signals leaving the polarization controllers 310. The photodiodes 510 produce electrical signals based on the optical signals leaving the polarization controllers 310. These electrical signals may be analyzed to monitor the optical signals leaving the polarization controllers 310. The fiber array unit 312 directs the optical signal to test equipment to test whether the line card 102 is operating correctly.

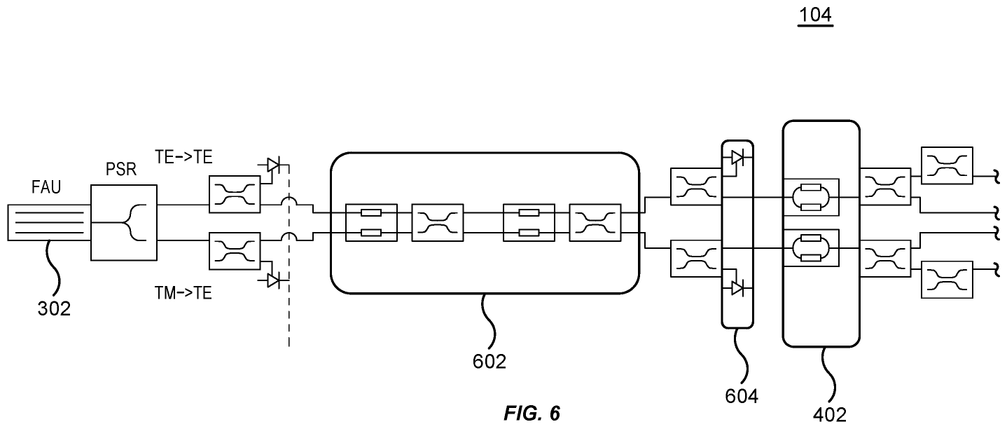

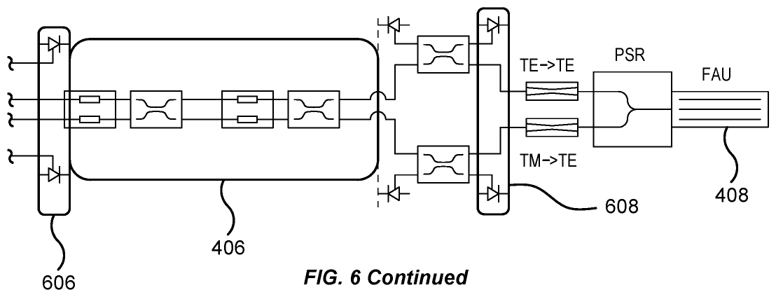

FIG. 6 illustrates an example optical module 104 in the system 100 of FIG. 1. Generally, FIG. 6 provides a more detailed schematic of the optical module 104 shown in FIG. 4. As seen in FIG. 6, the optical module 104 includes the fiber array unit 302 that receives optical signals from the line card 102. A polarization splitter rotator separates the optical signals from the fiber array unit 302 into transverse electric and transverse magnetic components. The polarization splitter rotator also rotates the transverse magnetic component into a transverse electric component. These transverse electric components are then directed to polarization controllers 602.

The polarization controllers 602 adjust the polarizations of the transverse electric components and directs these adjusted components to the variable optical attenuators 402. In some embodiments, the optical module 104 includes photodiodes 604 that tap into the optical signals leaving the polarization controllers 602. The photodiodes 604 produce electrical signals based on the optical signals leaving the polarization controllers 602. These electrical signals may be analyzed to monitor the optical signals leaving the polarization controllers 602.

The variable optical attenuators 402 attenuate or reduce the signal power in the optical signals from the polarization controllers 602. The amount of reduction may be adjusted or controlled. For example, the amount of reduction may be manually adjusted or adjusted using electrical signals into the variable optical attenuators 402. The variable optical attenuators 402 direct the attenuated optical signals to the polarization controllers 406. In some embodiments, the optical module 104 includes photodiodes 606 that tap into the optical signals leaving the variable optical attenuators 402. The photodiodes 606 produce electrical signals based on the optical signals leaving the variable optical attenuators 402. These electrical signals may be analyzed to monitor the optical signals leaving the variable optical attenuators 402.

The polarization controllers 406 adjust the polarizations of the optical signals from the variable optical attenuators 402. The polarization controllers 406 may direct these adjusted optical signals to the fiber array unit 408. In some embodiments, the optical module 104 includes the photodiodes 608 that tap into the optical signals leaving the polarization controllers 406. The photodiodes 608 produce electrical signals based on the optical signals leaving the polarization controllers 406. These electrical signals may be analyzed to monitor the optical signals leaving the polarization controllers 406.

A polarization splitter rotator may rotate and combine the optical signals from the polarization controllers 406. The polarization splitter rotator directs the optical signal to the fiber array unit 408. The fiber array unit 408 directs the optical signal out of the optical module 104 and to test equipment. The test equipment analyzes the optical signal from the fiber array unit 408 to determine whether the line card 102 is operating correctly.

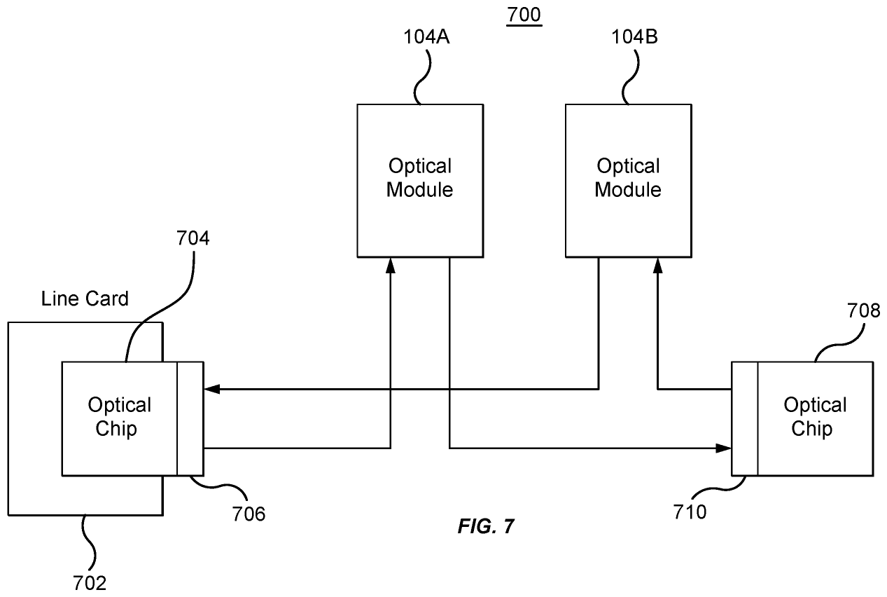

FIG. 7 illustrates an example optical system 700. As seen in FIG. 7, the system 700 includes the line card 702 and optical modules 104A and 104B. Generally, the optical modules 104A and 104B direct optical signals from the line card 702 to test equipment, and vice versa.

The line card 702 includes an optical chip 704. The optical chip 704 may include an optical port 706. The optical module 104A may plug in or couple to the optical port 706 on the optical chip 704. The optical chip 704 then directs an optical signal to the optical module 104A. The optical module 104A conditions the optical signal from the optical chip 704 and directs the conditioned optical signal to the optical chip 708.

The optical chip 708 (which may also be referred to as a receiver circuit) may be part of test equipment that analyzes the optical signal from the optical module 104A. The optical chip 708 includes an optical port 710. The optical module 104A may direct the conditioned optical signal to the optical port 710 on the optical chip 708.

The optical chip 708 may also direct optical signals to the optical chip 704 to receive or determine a response from the optical chip 704. The optical module 104B receives an optical signal from the optical chip 708 through the optical port 710. The optical module 104B conditions the optical signal and directs the conditioned optical signal to the optical chip 704 through the optical port 706. The optical module 104B may plug into or couple to the optical port 706 on the optical chip 704. The optical signal from the optical module 104B may elicit a response from the optical chip 704. The optical chip 704 may direct the response back to the optical chip 708 through the optical module 104A. In this manner, the system 700 tests the operation of the optical chip 704 and the line card 702 using test equipment that is separate from the line card 702.

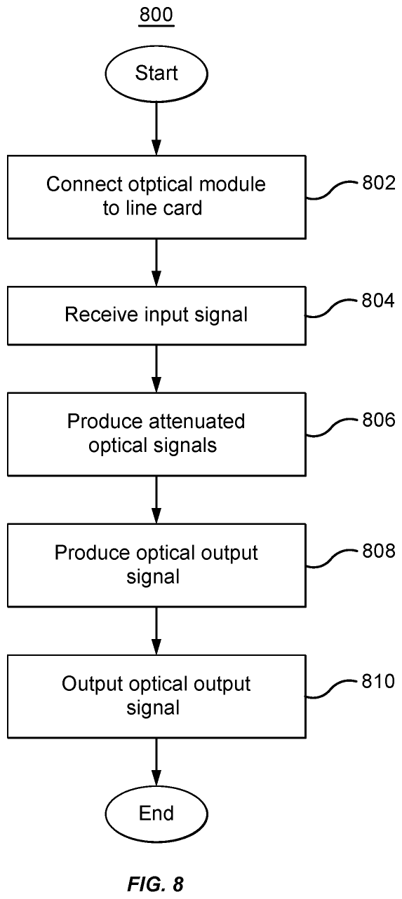

FIG. 8 is a flowchart of an example method 800 performed by the system 100 of FIG. 1 or the system 700 of FIG. 7. In particular embodiments, the optical module 104 performs the method 800. By performing the method 800, the optical module 104 conditions an optical signal from the line card 102 and directs the conditioned optical signal to test equipment.

In block 802, the optical module 104 is connected to the line card 102 or 702. The optical module 104 may be plugged into or connected to an optical port on the line card 102 or 702. In block 804, the optical module 104 receives an input optical signal from the line card 102 or 702. The optical module 104 may receive the input signal as a result of the optical module 104 plugging into or coupling to the optical port on the line card 102 or 702.

In block 806, the optical module 104 produces attenuated optical signals. For example, the optical module 104 may include variable optical attenuators that attenuate the optical signals from the line card 102 or 702. By attenuating the optical signals, the optical module 104 reduces the signal power in the optical signals. In block 808, the optical module 104 produces an output optical signal using polarization controllers. The polarization controllers adjust the polarizations of optical signals into the polarization controllers. These input signals to the polarization controllers may be based on the attenuated optical signals from the variable optical attenuators. For example, these input signals may be produced by one or more multiplexers that combine the attenuated optical signals from the variable optical attenuators.

In block 810, the optical module 104 outputs the optical output signal from the polarization controllers. The optical module 104 may output the optical output signal to the test equipment. The test equipment may analyze the optical output signal to determine whether the line card 102 or 702 is operating correctly.

In summary, the optical module 104 connects to an optical line card 102 to condition and direct optical signals in and from the optical line card 102 to test equipment. The optical module 104 includes variable optical attenuators that attenuate the optical signals and one or more polarization controllers that adjust the polarization of the optical signals. The optical module 104 may output the conditioned optical signals to test equipment to test the optical line card 102. In this manner, the optical line card 102 does not need to include test equipment, which reduces the space and real estate requirements for the optical line card.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer or firmware program instructions. These computer or firmware program instructions may be provided to a processor of a general purpose line card, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

The flowchart illustrations and block diagrams in the Figures illustrate the architecture, functionality, and operation of possible implementations of systems, methods, and firmware/software program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. An optical module comprising:
an optical connector port arranged to connect to an optical port on a line card and to receive an input optical signal from the line card when the optical connector port is connected to the optical port on the line card;
a plurality of variable optical attenuators arranged to produce a plurality of attenuated optical signals based on the input optical signal;
a first polarization controller arranged to produce an output optical signal based on the plurality of attenuated optical signals; and
an output port arranged to output the output optical signal.

2. The optical module of claim 1, further comprising a wavelength division multiplexing filter arranged to pass a plurality of wavelengths of the input optical signal, wherein producing the plurality of attenuated optical signals is based on the plurality of wavelengths.

3. The optical module of claim 1, further comprising a multiplexer arranged to produce an intermediate optical signal based on the plurality of attenuated optical signals, wherein producing the output optical signal is based on the intermediate optical signal.

4. The optical module of claim 1, further comprising a second polarization controller arranged to adjust a polarization of the input optical signal to produce an adjusted input optical signal, wherein producing the plurality of attenuated optical signals is based on the adjusted input optical signal.

5. The optical module of claim 1, further comprising a plurality of photodiodes arranged to produce a plurality of electrical signals based on the plurality of attenuated optical signals.

6. The optical module of claim 1, further comprising a photodiode arranged to produce an electrical signal based on the output optical signal.

7. The optical module of claim 1, wherein the optical connector port comprises a fiber array unit arranged to receive the input optical signal when the optical connector port is connected to the optical port on the line card.

8. The optical module of claim 1, wherein the output port is arranged to connect to a receiver circuit that tests the output optical signal.

9. A method comprising:
connecting, by an optical connector port, an optical module to an optical port on a line card;
receiving, at the optical module and through the optical connector port, an input optical signal from the line card when the optical connector port is connected to the optical port on the line card;
producing, by a plurality of variable optical attenuators of the optical module, a plurality of attenuated optical signals based on the input optical signal;
producing, by a first polarization controller of the optical module, an output optical signal based on the plurality of attenuated optical signals; and
outputting, by an output port of the optical module, the output optical signal.

10. The method of claim 9, further comprising passing, by a wavelength division multiplexing filter of the optical module, a plurality of wavelengths of the input optical signal, wherein producing the plurality of attenuated optical signals is based on the plurality of wavelengths.

11. The method of claim 9, further comprising producing, by a multiplexer of the optical module, an intermediate optical signal based on the plurality of attenuated optical signals, wherein producing the output optical signal is based on the intermediate optical signal.

12. The method of claim 9, further comprising adjusting, by a second polarization controller of the optical module, a polarization of the input optical signal to produce an adjusted input optical signal, wherein producing the plurality of attenuated optical signals is based on the adjusted input optical signal.

13. The method of claim 9, further comprising producing, by a plurality of photodiodes of the optical module, a plurality of electrical signals based on the plurality of attenuated optical signals.

14. The method of claim 9, further comprising producing, by a photodiode of the optical module, an electrical signal based on the output optical signal.

15. The method of claim 9, wherein the optical connector port comprises a fiber array unit arranged to receive the input optical signal when the optical connector port is connected to the optical port on the line card.

16. The method of claim 9, wherein the output port is arranged to connect to a receiver circuit that tests the output optical signal.

17. An optical module comprising:
an optical connector port arranged to connect to an optical port on a line card and to receive an input optical signal from the line card when the optical connector port is connected to the optical port on the line card;
a wavelength division multiplexing filter arranged to pass a plurality of wavelengths of the input optical signal;
a plurality of variable optical attenuators arranged to produce a plurality of attenuated optical signals based on the passed plurality of wavelengths of the input optical signal;
a multiplexer arranged to produce an intermediate optical signal based on the plurality of attenuated optical signals; and
a first polarization controller arranged to produce an output optical signal based on the intermediate optical signal.

18. The optical module of claim 17, further comprising a second polarization controller arranged to adjust a polarization of the input optical signal to produce an adjusted input optical signal, wherein passing the plurality of wavelengths of the input optical signal comprises passing the plurality of wavelengths of the adjusted input optical signal.

19. The optical module of claim 17, further comprising a plurality of photodiodes arranged to produce a plurality of electrical signals based on the plurality of attenuated optical signals.

20. The optical module of claim 17, further comprising a photodiode arranged to produce an electrical signal based on the output optical signal.
